(19) United States
(12) Patent Application Publication
(10) Pub. No.: US 2025/0125759 A1
(43) Pub. Date: Apr. 17, 2025

(54) CIRCUIT AND DEVICE FOR DRIVING MOTOR

(71) Applicants: KOSTAL (SHANGHAI) MECHATRONIC CO., LTD., Shanghai (CN); SHANGHAI KOSTAL-HUAYANG AUTOMOTIVE ELECTRIC CO., LTD., Shanghai (CN)

(72) Inventors: Hongjun HUANG, Shanghai (CN); Genghui WANG, Shanghai (CN); Yong GU, Shanghai (CN)

(73) Assignees: KOSTAL (SHANGHAI) MECHATRONIC CO., LTD., Shanghai (CN); SHANGHAI KOSTAL-HUAYANG AUTOMOTIVE ELECTRIC CO., LTD., Shanghai (CN)

(21) Appl. No.: 18/893,858

(22) Filed: Sep. 23, 2024

(30) Foreign Application Priority Data
Oct. 13, 2023 (CN) 2023 1 1331340.8
Apr. 19, 2024 (CN) 2024 1 0481416.3

(51) Int. Cl. H02P 27/08

(52) U.S. Cl. CPC H02P 27/08

(57) ABSTRACT

A circuit and a device for driving a motor. The circuit comprises a converting circuit and a driving circuit. An input terminal of the converting circuit is connected to a power supply. The converting circuit is configured to obtain a PMW waveform of which a complete cycle comprises a first half-cycle and a second half-cycle. The converting circuit comprises: a waveform generating circuit, comprising a first operational amplifier configured to provide a reference voltage and obtain the first half-cycle based on the reference voltage; and a waveform flipping circuit, comprising a second operational amplifier configured to flip the reference voltage to obtain the second half-cycle. An output terminal of the converting circuit is configured to transmit the PWM waveform to the input terminal of the driving circuit. The driving circuit is configured to control operation of the motor based on the PWM waveform.

This application claims priority to Chinese Patent Application No. 202311331340.8, titled “CIRCUIT AND DEVICE FOR DRIVING MOTOR”, filed on Oct. 13, 2023, and Chinese Patent Application No. 202410481416.3, titled “CIRCUIT AND DEVICE FOR DRIVING MOTOR”, filed on Apr. 19, 2024, both with the China National Intellectual Property Administration, each of which is incorporated herein by reference.

### FIELD

The present disclosure relates to the technical field of pulse width modulation, and in particular to, a method and a device for driving a motor.

### BACKGROUND

Pulse width modulation (PWM) is featured in fast and highly precise adjustment, and hence they are widely applied. Generally, a circuit for driving a motor may utilize a boost circuit or a buck circuit for charging a capacitor, so as to acquire a voltage capable to drive the motor. Amplitude of such voltage generated by the boost or buck circuit would not further change after reaching a certain threshold. During vibration of the motor, a transistor is controlled to be switched between on and off to generate a PWM waveform. The limitation on the amplitude of the driving voltage renders the PMW waveform in complete, e.g., only positive half cycles exists, which reduces efficiency of motor vibration

Therefore, how to improve the efficiency of motor vibration is an urgent issue to be addressed in the field.

### SUMMARY

A circuit and a device for driving a motor are provided according to embodiments of the present disclosure. Addressed is at least an issue that a pulse width modulation (PWM) waveform is incomplete due to a limitation on amplitude of a driving voltage.

In a first aspect, a circuit for driving a motor is provided according to embodiments of the present disclosure. The circuit comprises: a converting circuit and a driving circuit. An input terminal of the converting circuit is connected to a power supply. The converting circuit is configured to obtain a PWM waveform of which a complete cycle comprises a first half-cycle and a second half-cycle. The converting circuit comprises a waveform generating circuit and a waveform flipping circuit. The waveform generating circuit comprises a first operational amplifier configured to provide a reference voltage and obtain the first half-cycle of the cycle based on the reference voltage. The waveform flipping circuit comprises a second operational amplifier configured to flip the reference voltage to obtain the second half-cycle of the cycle. An output terminal of the converting circuit is connected to an input terminal of the driving circuit and is configured to transmit the PWM waveform to the input terminal of the driving circuit. An output terminal of the driving circuit is configured to connect the motor, and the driving circuit is configured to control operation of the motor based on the PWM waveform.

In an embodiment, the waveform generating circuit comprises a first capacitor, a second capacitor, a third capacitor, a first resistor, a second resistor, and a third resistor. A first terminal of the first capacitor and a first terminal of the second capacitor are both connected to the power supply. A second terminal of the first capacitor is connected to a first terminal of the first resistor. A second terminal of the first resistor is connected to an inverting input terminal of the first operational amplifier. A second terminal of the second capacitor is connected to a first terminal of the second resistor. A second terminal of the second resistor is connected to a non-inverting input terminal of the first operational amplifier. A positive power-supply terminal and a negative power-supply terminal of the first operational amplifier are both grounded. An output terminal of the first operational amplifier is connected to a common terminal serving as both a second terminal of the third capacitor and a second terminal of the third resistor. A common terminal serving as both a first terminal of the third capacitor and a first terminal of the third resistor is connected to the second terminal of the first resistor.

In an embodiment, the waveform flipping circuit comprises: a fourth capacitor, a fourth resistor, and a fifth resistor. A first terminal of the fourth resistor serves as an input terminal of the waveform flipping circuit. A second terminal of the fourth resistor is connected to an inverting input terminal of the second operational amplifier. A non-inverting input terminal of the second operational amplifier is grounded. An output terminal of the second operational amplifier is connected to a common terminal serving as both a second terminal of the fourth capacitor and a second terminal of the fifth resistor. The inverting input terminal of the second operational amplifier is connected to a common terminal serving as both a first terminal of the fourth capacitor and a first terminal of the fifth resistor.

In an embodiment, the waveform generating circuit further comprises a sixth resistor, a seventh resistor, a sixth capacitor, and a fifth capacitor. A first terminal of the sixth resistor is connected to the output terminal of the first operational amplifier. A second terminal of the sixth resistor is connected to a common terminal serving as both a first terminal of the fifth capacitor and a first terminal of the sixth capacitor. A second terminal of the sixth capacitor is grounded. A second terminal of the fifth capacitor is connected to a first terminal of the seventh resistor. A second terminal of the seventh resistor is connected to the input terminal of the driving circuit.

In an embodiment, the waveform flipping circuit further comprises an eighth resistor, a ninth resistor, a seventh capacitor, and an eighth capacitor. A first terminal of the eighth resistor is connected to the output terminal of the second operational amplifier. A second terminal of the eighth resistor is connected to a common terminal serving as both a first terminal of the seventh capacitor and a first terminal of the eighth capacitor. A second terminal of the seventh capacitor is grounded. A second terminal of the eighth capacitor is connected to a first terminal of the ninth resistor. A second terminal of the ninth resistor is connected to the input terminal of the driving circuit.

In an embodiment, the driving circuit comprises a threshold control circuit and a full-bridge output circuit. An input terminal of the threshold control circuit serves as the input terminal of the driving circuit. An output terminal of the threshold control circuit is connected to an input terminal of the full-bridge output circuit. An output terminal of the full-bridge output circuit serves as the output terminal of the driving circuit.

In an embodiment, the full-bridge output circuit comprises a first transistor, a second transistor, a third transistor, and a fourth transistor. A first terminal of the first transistor is connected to a direct-current power supply. A control terminal of the first transistor is connected to an output terminal of the first operational amplifier. A second terminal of the first transistor is connected to a first terminal of the second transistor. A control terminal of the second transistor is connected to the output terminal of the first operational amplifier. A second terminal of the second transistor is grounded. A first terminal of the third transistor is connected to the direct-current power supply. A control terminal of the third transistor is connected to an output terminal of the second operational amplifier. A second terminal of the third transistor is connected to a first terminal of the fourth transistor. A control terminal of the fourth transistor is connected to the output terminal of the second operational amplifier. A second terminal of the fourth transistor is grounded.

In an embodiment, the threshold control circuit comprises a ninth capacitor and a tenth capacitor. A first terminal of the ninth capacitor is connected to the output terminal of the first operational amplifier. A second terminal of the ninth capacitor is connected to the first terminal of the second transistor. A first terminal of the tenth capacitor is connected to the output terminal of the second operational amplifier. A second terminal of the tenth capacitor is connected to the first terminal of the fourth transistor.

In an embodiment, the power supply comprises multiple power sources. A terminal of each of the multiple power sources is grounded, and another terminal of each of the multiple power sources is connected to the input terminal of the converting circuit.

In a second aspect, a device for driving a motor is provided according to embodiments of the present disclosure. The device comprises any foregoing circuit for driving the motor.

Herein the circuit for driving the motor is provided. The input terminal of the converting circuit is connected to the power supply. The converting circuit is configured to obtain the PWM waveform of which the complete cycle comprises both the first half-cycle and the second half-cycle. The converting circuit comprises the waveform generating circuit and the waveform flipping circuit. The waveform generating circuit comprises the first operational amplifier configured to provide the reference voltage and obtain the first half-cycle of the cycle based on the reference voltage. The waveform flipping circuit comprises the second operational amplifier configured to flip the reference voltage to obtain the second half-cycle of the cycle. The output terminal of the converting circuit is connected to the input terminal of the driving circuit and is configured to transmit the PWM waveform to the input terminal of the driving circuit. The output terminal of the driving circuit is configured to connect the motor to control the operation of the motor based on the PWM waveform. Thus, the PWM waveform of which the complete cycle having both positive and second half-cycles can be obtained via the two-stage operational amplifiers. Addressed is the issue that the PWM waveform is incomplete due to the limitation on the amplitude of the driving voltage. Efficiency of motor vibration is improved.

The device for driving the motor according to embodiments of the present disclosure can achieve the same technical effects.

### BRIEF DESCRIPTION OF THE DRAWINGS

Hereinafter drawings to be applied in embodiments of the present disclosure or in conventional technology are briefly described, in order to clarify illustration of technical solutions according to embodiments of the present disclosure or in conventional technology. Apparently, the drawings in the following descriptions are only some embodiments of the present disclosure, and other drawings may be obtained by those skilled in the art based on the provided drawings without exerting creative efforts

FIG. 1 shows a circuit diagram of a circuit for driving a motor.

FIG. 2 shows a circuit diagram of another circuit for driving a motor.

FIG. 3 shows a circuit diagram of a circuit for driving a motor according to an embodiment of the present disclosure.

FIG. 4 shows a circuit diagram of a converting circuit according to an embodiment of the present disclosure.

FIG. 5 shows a circuit diagram of a driving circuit according to an embodiment of the present disclosure.

Reference numerals:

| | |
|---|---|
| 1: boost circuit | 2: buck circuit, |
| 10: converting circuit, | 11: driving circuit, |
| 12: waveform generating circuit, | 13: waveform flipping circuit, |
| 14: threshold control circuit. | 15: full-bridge output circuit. |

### DETAILED DESCRIPTION OF EMBODIMENTS

Hereinafter technical solutions in embodiments of the present disclosure are described clearly and completely in conjunction with the drawings in embodiments of the present closure. Apparently, the described embodiments are only some rather than all of the embodiments of the present disclosure. Any other embodiments obtained based on the embodiments of the present disclosure by those skilled in the art without any creative effort fall within the scope of protection of the present disclosure.

A circuit and a device for driving a motor are provided according to embodiments of the present disclosure. Addressed is at least an issue that a pulse width modulation (PWM) waveform is incomplete due to a limitation on amplitude of a driving voltage. Efficiency of motor vibration is improved.

Hereinafter the present disclosure is illustrated with reference to the drawings and embodiments, in order to help those skilled in the art understand technical solutions of the present disclosure.

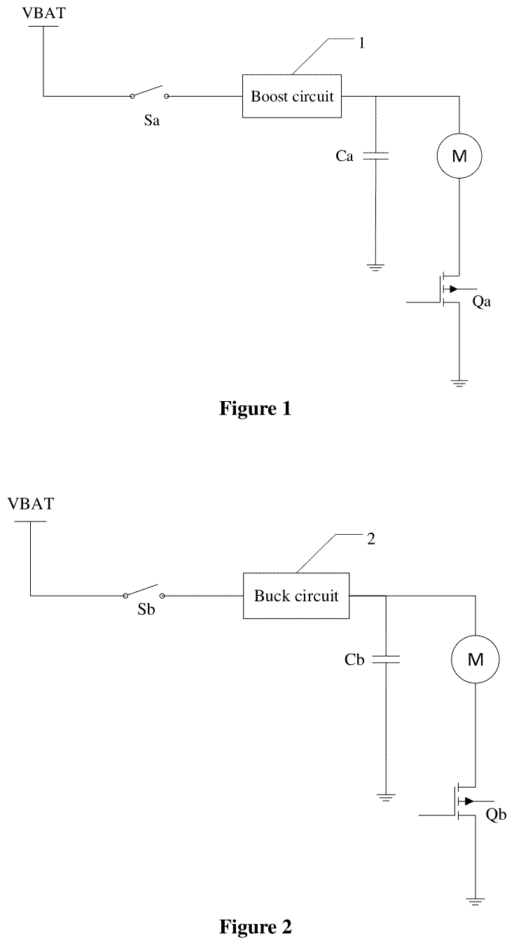

FIG. 1 shows a circuit diagram of a circuit for driving a motor. As shown in FIG. 1, the circuit comprises a first power-supply switch Sa, a boost circuit 1, a first driving capacitor Ca, a motor, and a first driving transistor Qa. A first terminal of the first power-supply switch is connected to a constant driving voltage VBAT. A second terminal of the first power-supply switch is connected to an input terminal of the boost circuit. An output terminal of the boost circuit is connected to a common terminal serving as both a first terminal of the first driving capacitor and a first terminal of the motor. A second terminal of the first driving capacitor is grounded. A second terminal of the motor is connected to a first terminal of the first driving transistor. A second terminal of the first driving transistor is grounded. A control terminal of the first driving switch is configured to receive a PWM waveform.

FIG. 2 shows a circuit diagram of another circuit for driving a motor. As shown in FIG. 2, the circuit comprises a second power-supply switch Sb, a buck circuit 2, a second driving capacitor Cb, a motor, and a second driving switch Qb. A first terminal of the second power-supply switch is connected to a constant driving voltage VBAT. A second terminal of the second power-supply switch is connected to an input terminal of the buck circuit. An output terminal of the buck circuit is connected to a common terminal serving as both a first terminal of the second driving capacitor and a first terminal of the motor. A second terminal of the second driving capacitor is grounded. A second terminal of the motor is connected to a first terminal of the second driving transistor. A second terminal of the second driving transistor is grounded. A control terminal of the second driving switch is configured to receive a PWM waveform.

Herein the constant driving voltage VBAT may be implemented as a power pin of a corresponding power module, such that the motor is powered via the power pin.

Herein the motor may be denoted as “M”. Basic configurations of the motor, such as an operation speed, a rated voltage, a rated current, may be determined according to an actual application scenario. Specifics of the motor are not limited herein. The motor may be represented by an inductor Lm and a resistor Rm which are connected in series. Considering an energy equation of Q=P*t=(U*U/R)*t, in which t represents a vibration period of the motor, P represents vibration power (which is also called vibration efficiency), and U represents a voltage provided by a power supply, the inductor is capable to provide sufficient magnetic flux for driving the motor, and a current flowing through the resistor generates Wallentz forces strong enough to make the motor vibrate. The resistor R may be tuned to provide a suitable current I for the driving circuit, where the current I determined based on an equation I=U/R. Vibration duration and vibration energy can be determined based on the vibration period.

In the foregoing circuits for driving the motor, the first driving capacitor is charged via the boost circuit, or the second driving capacitor is charged via the buck circuit. Thereby, the driving capacitor may store power for outputting a driving voltage, so as to drive operation of the motor based on the driving voltage. Amplitude of the driving voltage generated by the boost circuit or the buck circuit would not change after reaching a certain threshold. When the motor vibrates during its operation, a driving transistor is controlled to be switched between on and off through the PWM waveform received at a control terminal of the driving transistor. The limitation on the amplitude of the driving voltage determines that a cycle of the PMW waveform only have a position portion, that is, only the positive value is utilized to control operation of the motor. Hence, vibration efficiency of motor is reduced.

Moreover, the buck circuit performs regulation under a constant current, and its power supply should provide a voltage higher than its output voltage to ensure normal operation. For example, in a case that the output voltage is 5V, the input voltage shall be greater than 5V. As for the boost circuit, the output voltage of 5V indicates that the input voltage should be less than 5V.

Correspondingly, the buck circuit performs the regulation through a PWM waveform. That is, the buck circuit is capable to generate a voltage lower than the input voltage, and the regulation and control on the input voltage is implemented as follows: an average of the input voltage is adjusted through adjusting a duty cycle of a corresponding transistor. As for the boost circuit, the output voltage obtained need to be rectified by a rectifier for driving the motor.

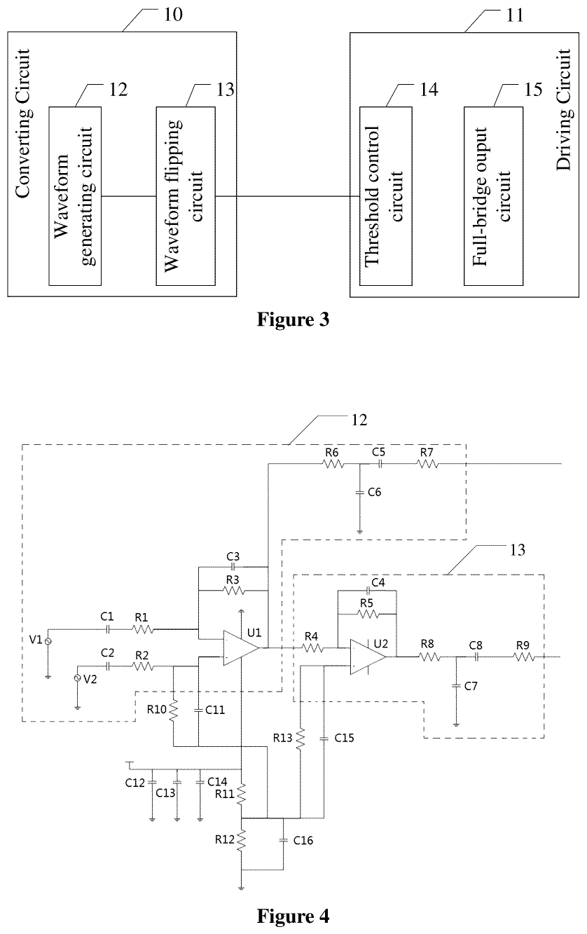

A circuit for driving a motor is provided according to embodiments of the present disclosure, in order to address at least the above issue. FIG. 3 shows a circuit diagram of a circuit for driving a motor according to an embodiment of the present disclosure. As shown in FIG. 3, the circuit comprises a converting circuit 10 and a driving circuit 11. An input terminal of the converting circuit 10 is connected to a power supply. The converting circuit 10 is configured to obtain a PWM waveform of which a complete cycle comprises a first half-cycle and a second half-cycle. The converting circuit 10 comprises a waveform generating circuit 12 and a waveform flipping circuit 13. The waveform generating circuit 12 comprises a first operational amplifier configured to provide a reference voltage and obtain the first half-cycle of the cycle based on the reference voltage. The waveform flipping circuit 13 comprises a second operational amplifier configured to flip the reference voltage to obtain the second half-cycle of the cycle. An output terminal of the converting circuit 10 is connected to an input terminal of the driving circuit 11 and is configured to transmit the PWM waveform to the input terminal of the driving circuit 11. An output terminal of the driving circuit 12 is configured to connect the motor, and the driving circuit 12 is configured to control operation of the motor based on the PWM waveform.

The power supply may be a circuit comprising multiple parallel power sources, and may adjust a voltage in real time based on a requirement of the motor. Herein the complete cycle of the PWM waveform may refer to that a non-zero waveform can be found throughout a whole cycle, rather than only a half of the cycle, of the PWM waveform. In an embodiment, the power supply comprises multiple power sources. For each power resource, one terminal (such as a negative terminal) is grounded, while another terminal (such as a positive terminal) is connected to an input terminal of the converting circuit. A quantity of the multiple power sources is at least two, for example, there are a power supply V1 and a power supply V2.

Thereby, in a case that an output voltage of the power supply is still equal to VBAT, the corresponding reference voltage is equal to VBAT/2. That is, the first operational amplifier is configured to provide the reference voltage equal to VBAT/2, and the second operational amplifier is configure to flip a PWM waveform having the reference voltage. In such case, a reference voltage corresponding to the flipped PWM waveform is equal to −VBAT/2. Thereby, the first half-cycle of the PWM waveform is obtained via the first operational amplifier, and the second half-cycle the PWM waveform is obtained via the second operational amplifier. The complete cycle of the PWM waveform may be obtained at the output terminal of the converting circuit. The PWM waveform having the complete cycles is obtained through two-stage operational amplifiers. Addressed is the issue that the PWM waveform is incomplete due to the limitation on the amplitude of the driving voltage. Efficiency of motor vibration is improved.

Moreover, an input terminal of the waveform generating circuit may serve as the input terminal of the converting circuit and may be connected to the power supply. The waveform generating circuit comprises the first operational amplifier. The output terminal of the waveform generating circuit is connected to the input terminal of the waveform flipping circuit. The waveform flipping circuit comprises the second operational amplifier. The output terminal of the waveform flipping circuit may serve as the output terminal of the converting circuit and may be connected to the input terminal of the driving circuit.

FIG. 4 shows a circuit diagram of a converting circuit according to an embodiment of the present disclosure. As shown in FIG. 4, the waveform generating circuit 10 further comprises a first capacitor C1, a second capacitor C2, a third capacitor C3, a first resistor R1, a second resistor R2, a third resistor R3, a sixth resistor R6, a seventh resistor R7, a fourth capacitor C4, and a fifth capacitor C5, besides the first operational amplifier U1. A first terminal of the first capacitor C1 and a first terminal of the second capacitor C2 are connected to the power supply. As shown in FIG. 4, the first terminal of the first capacitor C1 is connected to a terminal of the power source V1, and another terminal of the power source V1 is grounded. The first terminal of the second capacitor C2 is connected to a terminal of the power source V2, and another terminal of the power source V2 is grounded. A second terminal of the first capacitor C1 is connected to a first terminal of the first resistor R1. A second terminal of the first resistor R1 is connected to an inverting input terminal of the first operational amplifier U1. A second terminal of the second capacitor C2 is connected to a first terminal of the second resistor R2. A second terminal of the second resistor R2 is connected to a non-inverting input terminal of the first operational amplifier U1. A positive power-supply terminal of the first operational amplifier U1 is grounded. A negative power-supply terminal of the first operational amplifier is connected to a first terminal of an eleventh resistor R11. A second terminal of the eleventh resistor R11 is connected to a first terminal of a twelfth resistor R12. A second terminal of the twelfth resistor R12 is grounded. The first terminal of the eleventh resistor R11 is further connected to a first terminal of a fourteenth capacitor C14, a first terminal of a thirteenth capacitor C13, and a first terminal of a twelfth capacitor C12. A second terminal of the fourteenth capacitor C14, a second terminal of the thirteenth capacitor C13, and a second terminal of the twelfth capacitor C12 are all grounded. An output terminal of the first operational amplifier U1 is connected to a common terminal serving as both a second terminal of the third capacitor C3 and a second terminal of the third resistor R3. A common terminal serving as both a first terminal of the third capacitor C3 and a first terminal of the third resistor R3 is connected to the second terminal of the first resistor R1. A first terminal of the sixth resistor R6 is connected to the output terminal of the first operational amplifier U1. A second terminal of the sixth resistor R6 is connected to a common terminal serving as both a first terminal of the fifth capacitor C5 and a first terminal of the sixth capacitor C6. A second terminal of the sixth capacitor C6 is grounded. A second terminal of the fifth capacitor C5 is connected to a first terminal of the seventh resistor R7. A second terminal of the seventh resistor R7 is connected to the input terminal of the driving circuit.

In an embodiment, an amplification factor may be determined based on a ratio of resistance of the third resistor to resistance of the first resistor. The first operational amplifier may further have a function of filtering.

The waveform flipping circuit 11 further comprises a fourth capacitor C4, a fourth resistor R4, a fifth resistor R5, an eighth resistor R8, a ninth resistor R9, a seventh capacitor C7, and an eighth capacitor C8, besides the second operational amplifier U2. A first terminal of the fourth resistor R4 is connected to the output terminal of the first operational amplifier U1. A second terminal of the fourth resistor R4 is connected to an inverting input terminal of the second operational amplifier U2. An output terminal of the second operational amplifier U2 is connected to a common terminal serving as both a second terminal of the fourth capacitor C4 and a second terminal of the fifth resistor R5. The inverting input terminal of the second operational amplifier U2 is connected to a common terminal serving as both a first terminal of the fourth capacitor C4 and a first terminal of the fifth resistor R5. The non-inverting input terminal of the second operational amplifier is further connected to a first terminal of a thirteenth resistor R13 and a first terminal of a fifteenth capacitor C15. A second terminal of the thirteenth resistor R13 is connected to the first terminal of the twelfth resistor R12. A second terminal of the fifteenth capacitor C15 is connected to the first terminal of the twelfth resistor R12. A common terminal serving as both the second terminal of the thirteenth resistor R13 and the second terminal of the fifteenth capacitor is connected to a first terminal of the sixteenth capacitor C16. A second terminal of the sixteenth capacitor C16 is connected to the second terminal of the twelfth resistor R12. A first terminal of the eighth resistor R8 is connected to the output terminal of the second operational amplifier U2. A second terminal of the eighth resistor R8 is connected to a common terminal serving as both a first terminal of the seventh capacitor C7 and a first terminal of the eighth capacitor C8. A second terminal of the seventh capacitor C7 is grounded. A second terminal of the eighth capacitor C8 is connected to a first terminal of the ninth resistor R9. A second terminal of the ninth resistor R9 is connected to the input terminal of the driving circuit.

In the embodiment, another amplification factor may be determined based on a ratio of resistance of the fourth resistor R4 and resistance the fifth resistor R5. The twelfth capacitor C12, the thirteenth capacitor C13, and the fourteenth capacitor C14 may further have a function of filtering. Resistance of the sixth resistor R6 and resistance of the seventh resistor R7 are equal to resistance of the eighth resistor R8 and resistance of the ninth resistor R9, respectively. Capacitance of the fifth capacitor C5 and capacitance of the sixth capacitor C6 are equal to capacitance of the seventh capacitor C7 and the eighth capacitor C8. Thereby, it is convenient for the second operational amplifier to flip the received PWM waveform.

A waveform inputted into the waveform generating circuit may be a square wave, and intervals between adjacent high-levels may not be exactly the same. When another square wave is outputted from the waveform flipping circuit, the two-stage operational amplifiers have functioned to generate the complete cycle of the PWM waveform. Herein the complete cycle is formed by the first half-cycle, which is outputted from the waveform generating circuit, and the second half-cycle, which is obtained through flipping.

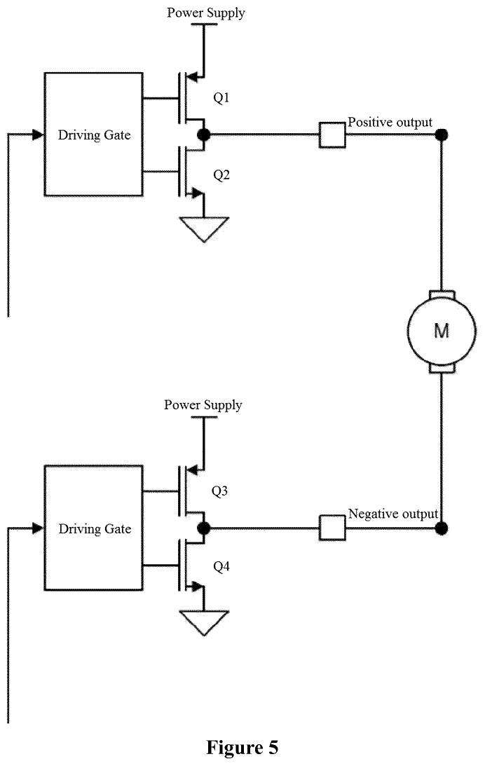

In an embodiment, the driving circuit comprises a threshold control circuit 14 and a full-bridge output circuit 15. An input terminal of the threshold control circuit serves as the input terminal of the driving circuit. An output terminal of the threshold control circuit is connected to an input terminal of the full-bridge output circuit. An output terminal of the full-bridge output circuit serves as the output terminal of the driving circuit. FIG. 5 shows a circuit diagram of a driving circuit according to an embodiment of the present disclosure. As shown in FIG. 5, the full-bridge output circuit comprises a first transistor Q1, a second transistor Q2, a third transistor Q3, and a fourth transistor Q4. A first terminal of the first transistor Q1 is connected to a direct-current power supply VCC. A control terminal of the first transistor Q1 is connected to the output terminal of the first operational amplifier U1. A second terminal of the first transistor Q1 is connected to a first terminal of the second transistor Q2. A control terminal of the second transistor Q2 is connected to the output terminal of the first operational amplifier U1. A second terminal of the second transistor Q2 is grounded. A first terminal of the third transistor Q3 is connected to the direct-current power supply VCC. A control terminal of the third transistor Q3 is connected to an output terminal of the second operational amplifier U2. A second terminal of the third transistor Q3 is connected to a first terminal of the fourth transistor Q4. A control terminal of the fourth transistor Q4 is connected to the output terminal of the second operational amplifier U2. A second terminal of the fourth transistor Q4 is grounded. A common terminal serving as both the second terminal of the first transistor Q1 and the first terminal of the second transistor Q2 serves as a sub-terminal of the output terminal of the driving circuit. A common terminal serving as both the second terminal of the third transistor Q3 and the first terminal of the fourth transistor Q4 serve as another sub-terminal of the output terminal of the driving circuit. Such two common terminals are both configured to connect the motor. The threshold control circuit comprises a ninth capacitor C9 and a tenth capacitor C10. A first terminal of the ninth capacitor C9 is connected to the output terminal of the first operational amplifier U1. A second terminal of the ninth capacitor C9 is connected to the first terminal of the second transistor Q2. A first terminal of the tenth capacitor C10 is connected to the output terminal of the second operational amplifier U2. A second terminal of the tenth capacitor C10 is connected to the first terminal of the fourth transistor Q4.

The full-bridge output circuit may refer to an H-bridge driving circuit. In a case that the full-bridge output circuit is the H-bridge driving circuit, a respective diode may be connected in parallel with each transistor. In such case, the first transistor to the fourth transistor can still be switched between on and off, so as to control forward rotation and reverse rotation of the motor and adjust a rotation speed of the motor.

Herein the first transistor, the second transistor, the third transistor, and the fourth transistor each may be a metal-oxide-semiconductor field-effect transistor (MOSFET). The MOSFET may be an n-channel MOSFET or p-channel MOSFET. A specific type of the transistor is not limited herein.

The MOSFETs have strong driving capability. A current of the MOSFET may be adjusted to a value ranging from 3 A to 12 A with high output power. Comprehensive fault protection may be provided through controlling the MOSFETs. For example, load unloading protection, short circuit protection, over-temperature protection, overvoltage protection, and under-voltage protection may be provided.

A device for driving a motor is further provided according to an embodiment of the present disclosure. The device comprises the circuit for driving the motor according to any foregoing embodiment. The device can also achieve that the PWM waveform of which the complete cycle having both positive and second half-cycles can be obtained via the two-stage operational amplifiers. Addressed is the issue that the PWM waveform is incomplete due to the limitation on the amplitude of the driving voltage. Efficiency of motor vibration is improved.

Following effects can be achieved according to embodiments of the present disclosure. The PWM waveform can be correspondingly adjusted to implement an optimum vibration power of the motor. Generally, a frequency of the PWM waveform ranges from 60 Hz to 300 Hz, and the frequency can be adjusted in correspondence to different cycles. The H-bridge driving circuit is utilized to provide a stable, sufficient, and efficient power to drive a vibrating component, such as a magnetic valve and a vibrating rotor, in the motor. The vibrating magnetic valve and the vibrating rotor may be connected in series and may be equivalent to a resistor and an inductor connected in series described above. Thereby, appropriate inductance and resistance may lead to different levels of vibration in motors having different parameters, maximize the vibration efficiency, and thereby ensure an optical operation state of the motor.

Hereinabove the circuit and the device for driving the motor are illustrate in detail according to embodiments of the present disclosure. The embodiments of the present disclosure are described in a progressive manner, and each embodiment places emphasis on the difference from other embodiments. Therefore, one embodiment can refer to other embodiments for the same or similar parts. Since the devices disclosed in the embodiments correspond to the circuits disclosed in the embodiments, the description of the devices is simple, and reference may be made to the relevant part of the circuits. Those skilled in the art may make improvements and modifications on a basis of the embodiments of the present disclosure without departing from a spirit of the present disclosure, and such improvements and modifications shall fall within the scope of the claims of the present disclosure.

The relationship terms such as “first”, “second” and the like are only used herein to distinguish one entity or operation from another, rather than to necessitate or imply that an actual relationship or order exists between the entities or operations. Furthermore, the terms such as “include”, “comprise” or any other variants thereof means to be non-exclusive. Therefore, a process, a method, an article or a device including a series of elements include not only the disclosed elements but also other elements that are not clearly enumerated, or further include inherent elements of the process, the method, the article or the device. Unless expressively limited, the statement “including a . . . ” does not exclude the case that other similar elements may exist in the process, the method, the article or the device other than enumerated elements.

1. A circuit for driving a motor, comprising a converting circuit and a driving circuit, wherein:
an input terminal of the converting circuit is connected to a power supply;
the converting circuit is configured to obtain a pulse width modulation (PMW) waveform of which a complete cycle comprises a first half-cycle and a second half-cycle;
the converting circuit comprises:
a waveform generating circuit, comprising a first operational amplifier configured to provide a reference voltage and obtain the first half-cycle based on the reference voltage; and
a waveform flipping circuit, comprising a second operational amplifier configured to flip the reference voltage to obtain the second half-cycle;
an output terminal of the converting circuit is connected to an input terminal of the driving circuit and is configured to transmit the PWM waveform to the input terminal of the driving circuit; and
an output terminal of the driving circuit is configured to connect the motor; and
the driving circuit is configured to control operation of the motor based on the PWM waveform.

2. The circuit according to claim 1, wherein:
the waveform generating circuit comprises a first capacitor, a second capacitor, a third capacitor, a first resistor, a second resistor, and a third resistor;
a first terminal of the first capacitor and a first terminal of the second capacitor are both connected to the power supply, and a second terminal of the first capacitor is connected to a first terminal of the first resistor;
a second terminal of the first resistor is connected to an inverting input terminal of the first operational amplifier;
a second terminal of the second capacitor is connected to a first terminal of the second resistor;
a second terminal of the second resistor is connected to a non-inverting input terminal of the first operational amplifier;
a positive power-supply terminal and a negative power-supply terminal of the first operational amplifier are both grounded;
an output terminal of the first operational amplifier is connected to a common terminal serving as both a second terminal of the third capacitor and a second terminal of the third resistor; and
a common terminal serving as both a first terminal of the third capacitor and a first terminal of the third resistor is connected to the second terminal of the first resistor.

3. The circuit according to claim 1, wherein:
the waveform flipping circuit comprises: a fourth capacitor, a fourth resistor, and a fifth resistor;
a first terminal of the fourth resistor serves as an input terminal of the waveform flipping circuit, and a second terminal of the fourth resistor is connected to an inverting input terminal of the second operational amplifier;
a non-inverting input terminal of the second operational amplifier is grounded;
an output terminal of the second operational amplifier is connected to a common terminal serving as both a second terminal of the fourth capacitor and a second terminal of the fifth resistor; and
the inverting input terminal of the second operational amplifier is connected to a common terminal serving as both a first terminal of the fourth capacitor and a first terminal of the fifth resistor.

4. The circuit according to claim 2, wherein:
the waveform generating circuit further comprises a sixth resistor, a seventh resistor, a sixth capacitor, and a fifth capacitor;
a first terminal of the sixth resistor is connected to the output terminal of the first operational amplifier, and a second terminal of the sixth resistor is connected to a common terminal serving as both a first terminal of the fifth capacitor and a first terminal of the sixth capacitor;
a second terminal of the sixth capacitor is grounded;
a second terminal of the fifth capacitor is connected to a first terminal of the seventh resistor; and
a second terminal of the seventh resistor is connected to the input terminal of the driving circuit.

5. The circuit according to claim 3, wherein:
the waveform flipping circuit further comprises an eighth resistor, a ninth resistor, a seventh capacitor, and an eighth capacitor;
a first terminal of the eighth resistor is connected to the output terminal of the second operational amplifier;
a second terminal of the eighth resistor is connected to a common terminal serving as both a first terminal of the seventh capacitor and a first terminal of the eighth capacitor;
a second terminal of the seventh capacitor is grounded;
a second terminal of the eighth capacitor is connected to a first terminal of the ninth resistor; and
a second terminal of the ninth resistor is connected to the input terminal of the driving circuit.

6. The circuit according to claim 1, wherein:
the driving circuit comprises a threshold control circuit and a full-bridge output circuit;
an input terminal of the threshold control circuit serves as the input terminal of the driving circuit;
an output terminal of the threshold control circuit is connected to an input terminal of the full-bridge output circuit; and
an output terminal of the full-bridge output circuit serves as the output terminal of the driving circuit.

7. The circuit according to claim 6, wherein:
the full-bridge output circuit comprises a first transistor, a second transistor, a third transistor, and a fourth transistor;
a first terminal of the first transistor is connected to a direct-current power supply, a control terminal of the first transistor is connected to an output terminal of the first operational amplifier, and a second terminal of the first transistor is connected to a first terminal of the second transistor;
a control terminal of the second transistor is connected to the output terminal of the first operational amplifier, and a second terminal of the second transistor is grounded;
a first terminal of the third transistor is connected to the direct-current power supply, a control terminal of the third transistor is connected to an output terminal of the second operational amplifier; and a second terminal of the third transistor is connected to a first terminal of the fourth transistor; and
a control terminal of the fourth transistor is connected to the output terminal of the second operational amplifier, and a second terminal of the fourth transistor is grounded.

8. The circuit according to claim 7, wherein:
the threshold control circuit comprises a ninth capacitor and a tenth capacitor;
a first terminal of the ninth capacitor is connected to the output terminal of the first operational amplifier, and a second terminal of the ninth capacitor is connected to the first terminal of the second transistor; and
a first terminal of the tenth capacitor is connected to the output terminal of the second operational amplifier, and a second terminal of the tenth capacitor is connected to the first terminal of the fourth transistor.

9. The circuit according to claim 1, wherein
the power supply comprises a plurality of power sources; and
for each power source of the plurality of power sources, a terminal of said power resource is grounded, and another terminal of said power source is connected to the input terminal of the converting circuit.

10. A device for driving a motor, comprising a circuit for driving the motor, wherein:
the circuit comprises a converting circuit and a driving circuit;
an input terminal of the converting circuit is connected to a power supply;
the converting circuit is configured to obtain a pulse width modulation (PMW) waveform of which a complete cycle comprises a first half-cycle and a second half-cycle;
the converting circuit comprises:
a waveform generating circuit, comprising a first operational amplifier configured to provide a reference voltage and obtain the first half-cycle based on the reference voltage; and
a waveform flipping circuit, comprising a second operational amplifier configured to flip the reference voltage to obtain the second half-cycle;
an output terminal of the converting circuit is connected to an input terminal of the driving circuit and is configured to transmit the PWM waveform to the input terminal of the driving circuit; and
an output terminal of the driving circuit is configured to connect the motor; and
the driving circuit is configured to control operation of the motor based on the PWM waveform.
